(19) United States
(12) Patent Application Publication
(10) Pub. No.: US 2008/0040052 A1
(43) Pub. Date: Feb. 14, 2008

(54) Pump Monitor

(76) Inventors: Toshimichi Wago, Houston, TX (US); Jean-Louis Pessin, Houston, TX (US); Ken Sheldon, Houston, TX (US)

Correspondence Address: SCHLUMBERGER TECHNOLOGY CORPORATION;David Cate, IP DEPT., WELL STIMULATION, 110 SCHLUMBERGER DRIVE, MD1, SUGAR LAND, TX, 77478, US

(21) Appl. No.: 11/464,030

(22) Filed: Aug. 11, 2006

(51) Int. Cl. G01B 3/44

(52) U.S. Cl. 702/34; 73/168

(57) ABSTRACT

A monitor for a pump. The monitor includes a regulation mechanism to monitor input power delivered to the pump. An estimated output power is compared to the input power over a period of time by a data processor of the monitor. In this manner, the monitor may be employed to establish a condition of a true output power of the pump. This may be of particular benefit in a multi-pump or other operation where direct measurement of pump output power is unavailable.

### BACKGROUND

Embodiments described relate to pump assemblies for a variety of applications. In particular, embodiments of monitoring the condition of individual pumps of a multi-pump assembly during operation is described.

### BACKGROUND OF THE RELATED ART

Multiple pumps are often employed simultaneously in large scale operations. The pumps may be linked to one another through a common manifold which mechanically collects and distributes the combined output of the individual pumps according to the parameters of the given operation. In this manner, high pressure large scale operations may be effectively carried out. For example, hydraulic fracturing operations often proceed in this manner with perhaps as many as twenty positive displacement pumps or more coupled together through a common manifold. A centralized computer system may be employed to direct the entire system for the duration of the operation. Such a multi-pump assembly may be employed to direct an abrasive containing fluid through a well into the earth for fracturing of rock thereat under extremely high pressure. Such techniques are often employed to release oil and natural gas from porous underground rock.

In the above described system, operational parameters may be set for each individual pump depending on that pump's anticipated contribution to the system as a whole. For example, in a moderately sized operation, six pumps may be coupled to a common manifold to provide 9,600 HP (horsepower) at a given point during the operation, each pump contributing about 1,600 HP. This may be achieved by operating the pump at about 1800 RPM (revolutions per minute) driven by application of about 2,000 HP thereto. That is, given an expected power loss or inefficiency of about 20% or so, running the pump in this manner may lead to an ultimate power output of the requisite 1,600 HP.

In the above described example, it is estimated that a given individual pump will be able contribute its 1,600 HP to the system when operating at 1800 RPM. However, generally only an estimate of the pump's power output is actually employed. That is, assuming that the pump is operating in a normal and healthy condition an estimated 1,600 HP should be provided by operation of the pump at 1800 RPM in the example described.

Unfortunately, estimating the power output as described above fails to account for circumstances in which an individual pump is operating in an unhealthy condition. For example, where there is a breach of fluid supply to the pump or malfunctioning of valves within the pump, the estimated power output is likely unrepresentative of the actual power output of the pump. That is, by way of the above example, even with the pump operating at 1800 RPM, it is likely that a pump with defective valves is failing to contribute its full 1,600 HP to the operation. With the failure of one of the individual pumps as described, the total power output of the system may decrease. This can affect the time and effectiveness of the overall operation.

Efforts to directly monitor the condition of each pump and its output may be addressed with the placement of a flow meter or other mechanism directly at the physical output of each pump. In this manner, there need not be sole reliance on merely an estimated output to determine the contribution of any individual pump to the multi-pump system's total operating power. However, reliance on a flow meter or other mechanical device directly at the output of an individual high pressure pump to directly monitor its output can be quite cumbersome and expensive in terms of placement and maintenance thereof. Therefore, rather than monitor each individual pump directly, pressure and other readings may be taken from the common manifold or other common area of the system. Thus, where a pressure drop to the system as a whole is sensed as a result of a defective pump, all of the pumps of the system may be directed to provide an increased output in order to compensate for the defective pump. However, this places added strain on the remaining pumps increasing the likelihood of their own failure during the operation. Furthermore, since the readings are taken from a common area such as the common manifold, this technique fails to even identify which pump is operating in a defective manner.

### SUMMARY

In one embodiment according to the present invention, a monitor for a pump is provided which includes a regulation mechanism coupled to the input of the pump to monitor input power applied thereto for a period of time. A data processor may be coupled to the regulation mechanism to analyze the input power relative to an estimated output power for the period of time. In this manner a condition of a true output power of the pump may be established.

### BRIEF DESCRIPTION OF THE DRAWINGS

FIG. 1 is a side sectional view of an embodiment of a monitor coupled to a pump.

FIG. 2 is an enlarged view of an embodiment of a valve taken from 2-2 of FIG. 1.

FIG. 3 is a chart depicting an embodiment of employing the monitor of FIG. 1 to reveal data relative to horsepower during operation of the pump.

FIG. 4 is a side sectional view of an embodiment of employing a multi-pump system in a fracturing operation.

FIG. 5 is a flow chart summarizing an embodiment of indirectly monitoring the condition of power output of a pump.

### DETAILED DESCRIPTION

Embodiments are described with reference to positive displacement pumps of a multi-pump assembly and methods applicable thereto. However, other types of pumps may be employed, including those that are not necessarily employed as part of a multi-pump assembly. Regardless, methods described herein may be particularly useful in monitoring the condition of output power for a given pump where the direct monitoring of output power is unavailable to a pump operator.

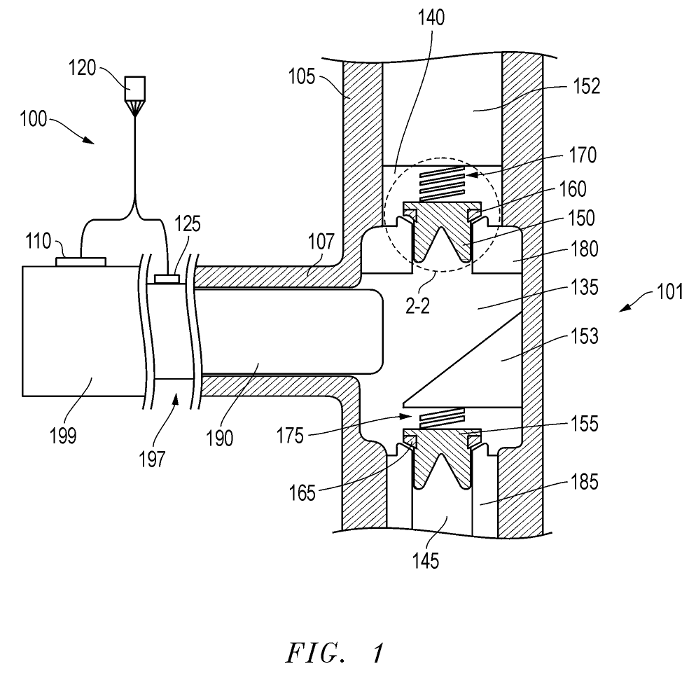

Referring to FIG. 1, an embodiment of a pump monitor 100 is shown coupled to a pump 101. In the embodiment shown, the pump 101 is a positive displacement pump. The monitor 100 includes a regulation mechanism 110 coupled to the power input of the pump 101. As shown, the input of the pump is an engine and transmission assembly 199. The regulation mechanism 110 may include or couple to a variety of feedback mechanisms and sensors relative to the engine and transmission assembly 199 such that its operation may be monitored and controlled. For example, in a given operation the regulation mechanism 110 may collect data relative to the engine and transmission assembly 199 such as actual torque or horsepower effected thereby. The regulation mechanism 110 may feed this data to a data processor 120 which may perform calculations thereon and in certain circumstances redirect operational parameters of the engine and transmission assembly 199, perhaps even back through the same regulation mechanism 110.

For sake of illustration certain data collection and direction of the engine and transmission assembly 199 is described above with reference to a regulation mechanism 110 which appears as a unitary device. However, the above described functions of the regulation mechanism 110 need not be accomplished through a regulation mechanism 110 of unitary construction. Rather, the collection of data and direction of the engine and transmission assembly 199 may be achieved through a variety of separate sensors and feedback implements to constitute a regulation mechanism 110. For example, along these lines other data regarding the speed directed to the pump 101 in operation is collected by a separate speed sensor as described below.

As alluded to above, a speed sensor in the form of a driveline speed sensor 125 may be employed to detect the speed that a driveline assembly 197 projects upon the plunger 190 of the pump 101 in operation. The driveline speed sensor 125 is mounted to the driveline assembly 197. In the embodiment shown, the driveline speed sensor 125 detects the position of a driveline within the driveline assembly 197 via conventional means such as by detection of a passing driveline clamp or other detectable device secured to the internal driveline. This position and timing information is conveyed to the data processor 120. The data processor 120 has stored information relative to the timing and order of the moving parts of the pump 101. Thus, calculations requiring a direct measurement of driveline speed may be performed.

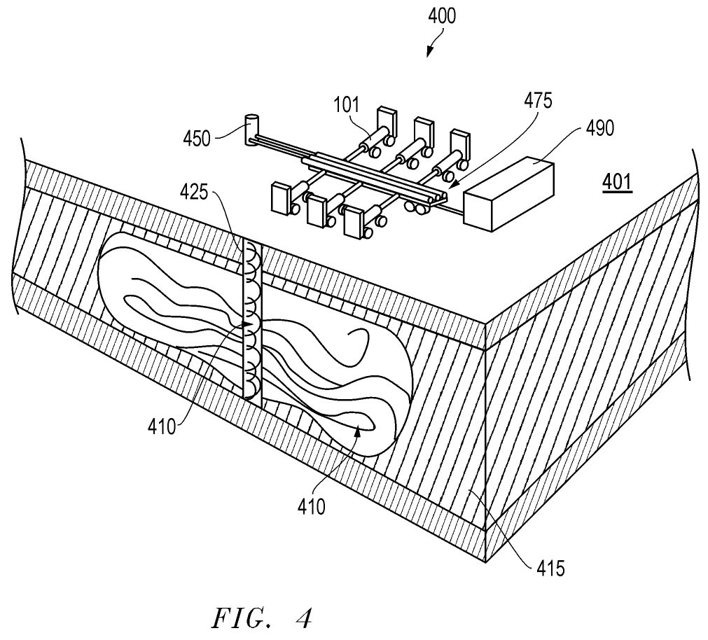

As indicated above detecting or directing horsepower and speed may be achieved with components of the pump monitor 100 including a data processor 120 that is coupled to a regulation mechanism 110 and a driveline speed sensor 125. For example, in one embodiment, the pump 101 may be set to operate at between about 1,500 and 2,000 RPM with the assembly generating about 2,000 HP of power input and translating to about an estimated 1,600 HP of power output by the pump 101. While an output power of 1,600 HP is an estimate, the monitor 100 may be employed to directly measure and address the operating parameters of input power in comparison thereto. In this manner, embodiments described herein employ the monitor 100 to help ensure that an individual pump 101 is functioning according to operational parameters relative to power output, even where direct monitoring of the power output of the individual pump 101 is unavailable such as may be the case in a multi-pump system 400 (see FIG. 4).

Continuing with reference to FIG. 1, the above-mentioned plunger 190 is provided for reciprocating within a plunger housing 107 toward and away from a chamber 135. In this manner, the plunger 190 effects positive and negative pressures on the chamber 135. For example, as the plunger 190 is thrust toward the chamber 135, the pressure within the chamber 135 is increased. At some point, the pressure increase will be enough to effect an opening of a discharge valve 150 to allow the release of fluid and pressure within the chamber 135. Thus, this movement of the plunger 190 is often referred to as its discharge stroke. Further, the point at which the plunger 190 is at its most advanced proximity to the chamber 135 is referred to herein as the discharge position. The amount of pressure required to open the discharge valve 150 as described may be determined by a discharge mechanism 170 such as spring which keeps the discharge valve 150 in a closed position until the requisite pressure is achieved in the chamber 135.

As described above, the plunger 190 also effects a negative pressure on the chamber 135. That is, as the plunger 190 retreats away from its advanced discharge position near the chamber 135, the pressure therein will decrease. As the pressure within the chamber 135 decreases, the discharge valve 150 will close returning the chamber 135 to a sealed state. As the plunger 190 continues to move away from the chamber 135 the pressure therein will continue to drop, and eventually a negative pressure will be achieved within the chamber 135. Similar to the action of the discharge valve 150 described above, the pressure decrease will eventually be enough to effect an opening of an intake valve 155. Thus, this movement of the plunger 190 is often referred to as the intake stroke. The opening of the intake valve 155 allows the uptake of fluid into the chamber 135 from a fluid channel 145 adjacent thereto. The point at which the plunger 190 is at its most retreated position relative to the chamber 135 is referred to herein as the intake position. The amount of pressure required to open the intake valve 155 as described may be determined by an intake mechanism 175 such as spring which keeps the intake valve 155 in a closed position until the requisite negative pressure is achieved in the chamber 135.

As described above, a reciprocating motion of the plunger 190 toward and away from the chamber 135 within the pump 101 controls pressure therein. The valves 150, 155 respond accordingly in order to dispense fluid from the chamber 135 and through a dispensing channel 140 at high pressure. That fluid is then replaced with fluid from within a fluid channel 145. This effective cycling of the pump 101 as described relies on the discrete and complete closure of the valves 150, 155 onto the valve seats 180, 185 following a discharge or intake of fluid with respect to the chamber 135. However, as described below, complete closure or sealing off of the chamber 135 may be prevented by a defect in the valve 150, 155. Additionally, lack of fluid to the pump 101 or other supply problems may lead to ineffective power output by the pump 101.

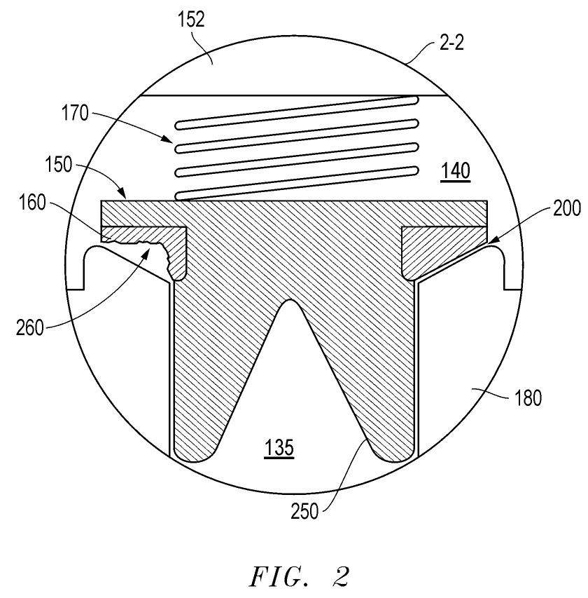

Referring now to FIG. 2, an enlarged view of the discharge valve 150 taken from section lines 2-2 of FIG. 1 is shown. The discharge valve 150 is shown biased between the discharge valve seat 180 and a discharge plane 152 by way of the spring discharge mechanism 170. In the embodiment shown, the discharge valve 150 includes valve legs 250 and a valve insert 160. The valve legs 250 guide the discharge valve 150 into a portion of the pump chamber 135 in order to seal the chamber 135 off from the dispensing channel 140 as described above. In circumstances of healthy valve closure, the chamber 135 is ultimately sealed off when the discharge valve seat 180 is struck by the discharge valve 150 with its conformable valve insert 160. As described below, employment of a conformable valve insert 160 for sealing off of the chamber 135 is conducive to the pumping of abrasive containing fluids through the pump 101 of FIG. 1.

As described above, effective power output by the pump 101 depends in part on proper fluid supply, proper cycling, and complete closure of the valves 150, 155 with the valve seats 180, 185 during cycling (see also FIG. 1). However as shown in FIG. 2, a damaged portion 260 of a valve insert 160 may prevent a completed seal from forming between the valve 150 and the valve seat 180, allowing leakage between the chamber 135 and the dispensing channel 140. When this occurs, the true power output by the pump 101 of FIG. 1 may be severely compromised as detailed further below.

Continuing with reference to FIG. 2, a positive displacement pump 101 is well suited for high pressure applications of abrasive containing fluids as noted above (see also FIG. 4). In fact, embodiments described herein may be applied to cementing, coiled tubing, water jet cutting, and hydraulic fracturing operations, to name a few. However, where abrasive containing fluids are pumped, for example, from a chamber 135 and out a valve 150 as shown in FIG. 2, it may be important to ensure that abrasive within the fluid not prevent the valve 150 from sealing against the valve seat 180. For example, in the case of hydraulic fracturing operations, the fluid pumped through a positive displacement pump 101 may include an abrasive or proppant such as sand, ceramic material or bauxite mixed therein. By employing a conformable valve insert 160, any proppant present at the interface 200 of the valve 150 and the valve seat 180 substantially fails to prevent closure of the valve 150. That is, the conformable valve insert 160 is configured to conform about any proppant present at the interface 200, thus allowing the valve 150 to seal off the chamber 135 irrespective of the presence of the proppant.

With added reference to FIG. 1, the above described technique of employing a conformable valve insert 160 where an abrasive fluid is to be pumped does allow for improved sealability of valves. However, it also leaves the valve 150 susceptible to degradation by the abrasive fluid. That is, a conformable valve insert 160 may be made of urethane or other conventional polymers susceptible to degradation by an abrasive fluid. In fact, in conventional hydraulic fracturing operations, a conformable valve insert 160 may degrade completely after approximately one to six weeks of continuous use. As this degradation begins to occur, a leak proof seal fails to form between the valve 150 and the valve seat 180.

Effects of the above described degradation may be seen at the damaged portion 260 of the valve insert 160. It can be seen that closure of the valve 150 against the valve seat 180 will not prevent leakage of fluid at the interface 200 thereof due to the presence of the damaged portion 260. As noted above, a growing leak such as this, between the chamber 135 and the dispensing channel 140, may severely affect the power output by the pump 101 in a given operation. Embodiments described herein reveal methods for identifying such a leak or other fluid supply issue affecting actual power output of an individual pump 101 even when operating in a multi-pump system or other fashion wherein no direct power output measurement is available. As described below, these techniques involve analyzing power input in light of the estimated power output.

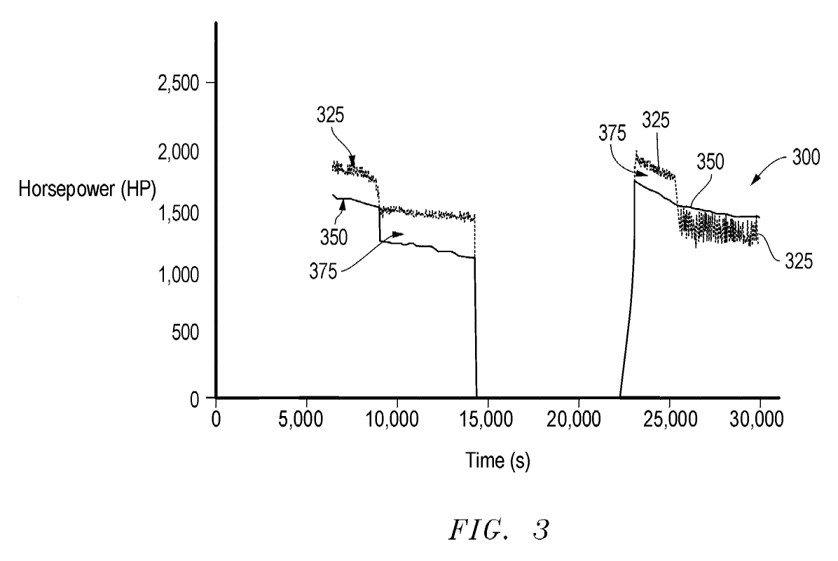

With reference to FIGS. 1-4, techniques for monitoring actual power output conditions of an operating pump 101 is shown in the form of the chart of FIG. 3. These techniques may be of particular benefit in examining the pump 101 as part of a multi-pump system 400 or other circumstances in which actual power output conditions of the pump 101 are not directly measured. As indicated above, methods described herein reveal how monitoring the power input 325 in relation to an estimated power output 350 for an individual pump 101 over time may be used to establish the condition of the actual power output of the pump 101, in spite of the fact that no direct measurement of the power output is made.

Continuing with reference to FIGS. 1-3, the above technique is described in further detail. As shown in FIG. 3, the actual power input 325 of the operating pump over time is known. For example, in the embodiment shown, 1,000 HP of power input 325 may be provided to the pump 101 for any given period of operation. The power input 325 may be directed by the data processor 100 or other means. Additionally, the power input 325 may be directly detected and calculated on an ongoing basis. For example, the driveline speed sensor 125 may be used to establish the driveline speed or RPM applied to the plunger 190 of the pump 101 in operation which, when multiplied by the torque as directly measured by the regulation mechanism 110 may provide a direct and true measurement of power input 325 into the pump 101. A record of this power input 325 by the engine and transmission assembly 199 into the pump 101 over time may be seen in the chart of FIG. 3.

While the above described power input 325 may be directly measured, the power output 350 by the pump 101 is often not directly measured for reasons noted above. However, power output 350 may be estimated for a given pump 101 operating in a healthy condition. For example, depending on the particular type of pump 101 and operational parameters, power output 350 may be estimated at between about 70-80% of the intended power input 325 for a given operation of the pump 101. The particular estimate of power output 350 may be pump 101 and operation specific depending on factors such as the output pressure and pump rate.

The estimated power output 350 as shown in FIG. 3 assumes that the pump is operating in a healthy condition. For example, the pump rate that is factored into the calculation of estimated power output 350 presumes a particular rate of efficiency, for example, in terms of Barrels Per Minute (BPM) in light of the Rate Per Minute (RPM) of the reciprocating pump 101. That is, data provided by the driveline sensor 125 may be extrapolated by the data processor 120 or other means into RPM data for the reciprocating pump 101. From this RPM information, a pump rate that assumes a given level of efficiency will be used in establishing an estimated power output 350 for the pump.

The chart of FIG. 3 reveals an estimated power output 350, extrapolated from RPM data as described above, and that presumes a given level of efficiency when the pump 101 operates. As the pump 101 changes RPM up or down, the estimated power output 350 is adjusted accordingly. In the first 15,000 seconds or so of the chart of FIG. 3 it can be seen that the estimated power output 350 is above 1500 HP in the operating pump 101 and as time goes on, eventually the estimated power output 350 makes its way down to just above about 1,000 HP.

Continuing with reference to the first 15,000 seconds or so, it is apparent that the estimated power output 350 remains a given substantially constant amount below the power input 325. As mentioned above, this is a naturally present degree of inefficiency 375. That is, the power input 325 provided by the engine and transmission assembly 199 to the pump 101 will translate to an estimated power output 350 that is somewhat less than the power input 325. In the embodiment shown in FIG. 3, about 2,000 HP of power input may be employed at the outset of a pump operation to provide an estimated 1,600 HP of power output by the pump 101. As described above, this is to be expected.

Assuming a healthy and effectively operational pump 101, monitoring the estimated power output 350 as described above may provide an operator with a fair idea of the amount of power actually contributed by an individual pump 101, for example, to an operation employing a multi-pump system. However, as noted with particular reference to FIG. 2, the effectiveness of the pump 101 does not necessarily remain healthy and constant. As such circumstances arise, the estimated power output 350 becomes unreliable. For example, deterioration of a valve insert 160, lack of fluid supply and other problems may arise which may drastically alter the true pump rate or effectiveness of the operating pump 101. When the true pump rate (i.e. in BPM) of the pump 101 is altered in this manner, the estimated power output 350 becomes unreliable. This is because the estimated power output 350 relies on RPM values for the pump 101 rather than a true or direct measurement of pump rate. Therefore, problems affecting a true pump rate fail to be factored into the estimated power output 350.

The above-described unreliability of the estimated power output 350 is revealed in another portion of the chart of FIG. 3. Specifically, when examining the pump operation depicted at between about 20,000 seconds and about 30,000 seconds, an unhealthy condition in the operating pump 101 may be diagnosed when examining the power input 325 in light of the estimated power output 350 over this time frame. That is, initially, after 20,000 seconds, as power input 325 begins to register, the estimated power output 350 also begins to appear somewhat below the power input 325 as expected. Soon thereafter, just prior to 25,000 seconds, output error 300 presents itself. This output error 300 described further below, may be analyzed and relayed by the pump monitor 100 for alerting an operator of the pump 101.

The above-noted region of output error 300 presents itself in the chart of FIG. 3 as the power input 325 drops while at this same time, the estimated power output 350 fails to correspondingly drop therebelow. Thus, no degree of inefficiency 375 is present at this region of output error 300. Given the impossibility of the true power output obtained from a pump 101 suddenly becoming larger than the power input 325 into the pump 101, it is apparent that there is a problem with the estimated power output 350 that is depicted in this region of output error 300. As described below, this problem may be attributable to a problem with the operation of the pump 101.

The embodiment shown in FIG. 3 represents a pump 101 that is set to operate at given RPM's with the idea of obtaining given pump rates (i.e. in BPM) from the individual pump 101 over the course of an operation. When there is a failure of the pump 101 in terms of events such as lack of fluid supply or leakage into the valves of the pump (see FIG. 2), the amount of power input 325 necessary to maintain a called for RPM lessens. That is, with such failures, fluid resistance is lessened and the power input 325 necessary to supply the driveline assembly 197 or reciprocate the plunger 190 becomes less. This can be seen in the drop in power input 325 at about the 25,000 second area of the depicted operation. As indicated, however, this drop in power input 325 is not accompanied by a requisite drop in estimated power output 350. Rather, the power input 325 actually falls to below the estimated power output 350.

As indicated above, the embodiment shown in FIG. 3 represents a pump 101 that is set to operate at given RPM's with the idea of obtaining given pump rates, and power output. However, the estimated power output 350 of FIG. 3, is an estimate that has no way of accounting for the emerging pump failure noted above. Rather, this value takes into account the known RPM and accordingly assigns a value to pump rate in estimating power output. However, when pump failure arises as described above, the RPM ceases to be an accurate gauge of pump rate. Thus, as shown in FIG. 3 at about 25,000 seconds, output error 300 presents itself as the estimated power output 350 fails to respond to the pump failure, maintaining values based solely an unaffected RPM and assuming inaccurate pump rates based thereon.

In spite of the unreliability of the estimated power output 350 alone in the face of pump failure, when examined in light of power input 325, output error 300 may be revealed providing an operator valuable information as to the condition of actual power output of a pump. In the embodiment shown in FIG. 3, an expected inefficiency of about 20% is present at the outset of an operation and suddenly disappears at under about 25,000 seconds into the operation. Thus, it is apparent that pump failure is occurring. However, in other embodiments, the condition of a pump 101 in operation may be more gradually deteriorating such that the expected inefficiency 375 gradually diminishes more gradually. Regardless, where the expected inefficiency 375 diminishes over the course of a given operation of an individual pump 101, output error 300 is present and the emergence of problems leading to pump failure and diminishing actual output may be relayed to an operator of the pump 101 with use of the pump monitor 100.

By employing embodiments described herein, error in pump output may be detected even though no actual pump output has been directly measured. As noted above, this may be particularly beneficial for monitoring the condition of an individual pump 101 of a multi-pump system 400 where direct measurement of each individual pump output may be unavailable.

The above described method of diagnosing pump output problems provides an example of a pump operation wherein the pump 101 is to operate at set RPM's with the idea of correlating presumed pump rates in order to establish the estimated power output 350. However, embodiments described herein may be employed for other pump operation parameters. For example, a given engine and transmission assembly 199 may be set to operate at given power input 325 levels (as opposed to effecting set RPM's). In these circumstances pump failure would lead to a decrease in fluid resistance and, as such, an increase in RPM's of the pump 101 as the pump 101 was provided its consistent power input 325 levels. Therefore, as opposed to a decrease in power input 325 as shown at about 25,000 seconds in the chart of FIG. 3, an increase in estimated power output 350 would be visible, again reducing the expected inefficiency 375. Thus, regardless of the operation type, diminishing of the expected inefficiency 375 reveals output error 300 representing problems with the true output of the individual pump 101.

Referring now to FIG. 4 specifically, multiple positive displacement pumps 101 are shown in simultaneous operation as part of a single multi-pump system 400 at the same hydraulic fracturing site 401. Each pump 101 may be driven with a known amount of input power (e.g. about 2,000 HP) to contribute an estimated amount of output power (e.g. 1,600 HP) to the operation of the multi-pump system 400. In this manner, a total output (e.g. 9,600 HP) of the six pump system may be employed to propel an abrasive fluid 410 through a well head 450 and into a well 425. The abrasive fluid 410 contains a proppant such as sand, ceramic material or bauxite provided from a blender 490 and for disbursing beyond the well 425 into fracturable rock 415 or other earth material.

In the embodiment shown in FIG. 4 input power to each pump 101 is provided on an individual basis allowing for the direct monitoring thereof. However, each pump 101 is in fluid communication with all others via a common manifold 475 that receives a combined amount of power from all of the pumps 101. Therefore, determining the output power provided by any individual pump 101 may be difficult to attain with examination of manifold conditions. Nevertheless, embodiments described above may be employed to ascertain the true condition of power output for each pump 101 on an individual basis. This may be achieved by comparison of the power input for a given pump 101 with the estimated power output for that same pump 101.

Continuing with reference to FIGS. 1-4, in a multi-pump operation each data processor 120 for each monitor 100 of each pump 101 may be independently coupled to a centralized computer system, for example, employing a graphical user interface (GUI), where an operator may review the operating condition of each pump 101 simultaneously. In a multi-pump operation, the operator may be able to monitor the presence or severity of any given output error 300 and, where necessary, interact with the GUI to effect modifications in the parameters of the operation, including at individual pumps 101. In this manner, the efficiency and effectiveness of the multi-pump system 400 may be maximized.

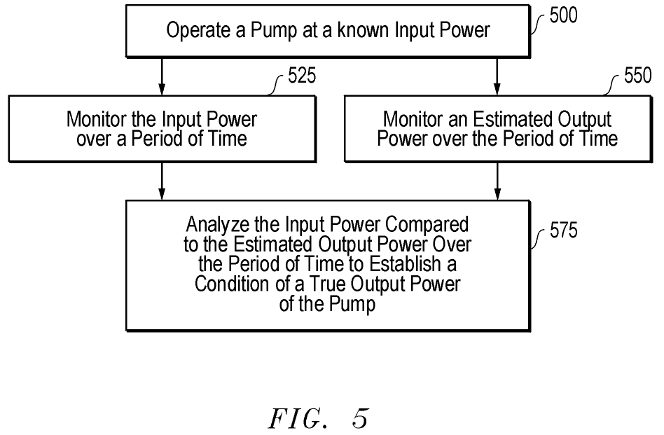

Referring now to FIG. 5 with added reference to FIG. 1, an embodiment of indirectly monitoring a condition of true output power of a pump is summarized in the form of a flow chart. Namely, a pump 101 is operated at a known level of input power as indicated at 500. This may be achieved with a data processor 120 directing a regulation mechanism 110 at an engine and transmission assembly 199 as described above. The regulation mechanism 110 may also be employed to communicate with the data processor 120 such that the input power may be monitored over a given period of time as indicated at 525. Similarly, an estimated output power may be monitored for this same period of time as indicated at 550. As described above, data such as RPM of the operating pump 101, may be monitored by a driveline speed sensor 125 and extrapolated by the data processor 120 in order to keep track of the estimated power output.

The data processor 120 of the pump monitor 100 may be employed to analyze the known input power as compared to the estimated output power over the period of time referenced above. In this manner, the data processor 120 may establish a condition of a true output power of the pump 101 as indicated at 575. For example, where an expected inefficiency 375 (see FIG. 3) or difference between the known input power and the estimated output power begins to diminish over the period, an unhealthy output power of the pump 101 may be diagnosed. Conversely, where this difference is substantially maintained, the output power of the pump 101 may be considered healthy for the given period. These conclusions may be drawn even though no direct monitoring of output power of the pump 101 has taken place.

The embodiments described herein provide embodiments of a monitor and method for determining the condition of output power of a pump even where no direct measurement of output power is available. Thus, the potential unreliability of an estimated power output of a pump, for example, of a multi-pump operation, may be overcome. As a result, the efficiency and effectiveness of such an operation may be maximized. This may be achieved without the need for use of a flow meter or other cumbersome device at the output of the pump. Further, employment of the embodiments of the monitor and method may allow for the identification of an unhealthy pump in a multi-pump operation thereby avoiding added strain to other pumps of the system.

Although exemplary embodiments describe particular monitoring of positive displacement pumps, for example, in multi-pump hydraulic fracturing operations, additional embodiments are possible. Furthermore, many changes, modifications, and substitutions may be made without departing from the scope of the described embodiments.

We claim:

1. A method comprising:
operating a pump;
collecting input power information from the pump during said operating;
obtaining estimated output power information during said operating; and
determining a true condition of output power of the pump by comparison of the input power information and the estimated output power information.

2. The method of claim 1 wherein said obtaining further comprises:
acquiring speed information relative to the pump during the operating;
presuming a pump rate based on the speed information; and
extrapolating the estimated output power information from the pump rate.

3. The method of claim 1 wherein said determining further comprises evaluating an expected inefficiency of the estimated power output below the input power during said operating.

4. The method of claim 3 wherein said evaluating further comprises monitoring the expected inefficiency for substantial consistency to indicate a healthy true condition of output power.

5. The method of claim 3 wherein said evaluating further comprises monitoring the expected inefficiency for a decrease over a period of said operating to indicate an unhealthy true condition of output power.

6. The method of claim 5 wherein said operating is at a substantially constant speed, the decrease a result of a drop in input power required to maintain the substantially constant speed.

7. A method comprising:
operating a pump;
collecting input power information from the pump during said operating;
obtaining estimated output power information during said operating by acquiring speed information relative to the pump during the operating; presuming a pump rate based on the speed information; and extrapolating the estimated output power information from the pump rate; and
establishing a true condition of output power of the pump by comparison of the input power information and the estimated output power information by evaluating an expected inefficiency of the estimated power output below the input power during said operating.

8. The method of claim 7 wherein said evaluating further comprises monitoring the expected inefficiency for substantial consistency to indicate a healthy true condition of output power.

9. The method of claim 7 wherein said evaluating further comprises monitoring the expected inefficiency for decrease over a period of said operating to indicate an unhealthy true condition of output power.

10. The method of claim 9 wherein said operating is at a substantially constant speed, the decrease a result of a drop in input power required to maintain the substantially constant speed.

11. A method comprising:
operating pumps in fluid communication with one another;
collecting separate input power information from each pump during said operating;
obtaining separate estimated output power information from each pump during said operating; and
establishing a true condition of output power for each pump by comparison of the input power information of each pump with its estimated output power information.

12. The method of claim 11 further comprising displaying a representation of the true condition of output power for each pump at a graphical user interface coupled through a centralized computer system to each of the pumps.

13. A monitor for a pump in operation, the monitor comprising:
a regulation mechanism coupled to an input power supply of the pump to obtain parameters relating to an input power applied to the pump for a period of time; and
a data processor coupled to the regulation mechanism which calculates the input power applied to the pump based on said parameters obtained from the regulation mechanism, and compares the input power to an estimated output power for said period of time to determine a condition of a true output power of the pump.

14. The monitor of claim 13 wherein the data processor calculates an expected inefficiency between the input power and the estimated power output, and wherein a reduction in the expected inefficiency indicates a failing condition of the true output power.

15. The monitor of claim 13 further comprising a speed sensor coupled to the pump and the data processor, said speed sensor to detect a speed of the pump in operation to allow said data processor to determine the estimated output power.

16. The monitor of claim 15 wherein said speed sensor is a driveline speed sensor coupled to a driveline assembly directed at a plunger of the pump.

17. The monitor of claim 13 wherein the pump is a positive displacement pump.

18. The monitor of claim 17 wherein the pump includes a plunger for reciprocation relative to a chamber of the pump during operation, the chamber to be sealed by at least one valve striking at least one valve seat defining the chamber.

19. The monitor of claim 18 wherein the valve includes a conformable valve insert to contact the valve seat during the striking.

20. The monitor of claim 13 wherein the input power supply is an engine and transmission assembly of the pump.

21. A pump assembly comprising:
a pump having an input; and
a monitor having a regulation mechanism coupled to the input to monitor input power applied to the pump and a data processor to analyze the input power relative to an estimated output power for a period of time to establish a condition of a true output power of the pump.

22. The assembly of claim 21 for employment in a hydraulic fracturing operation.

23. The assembly of claim 21 wherein said pump is a first pump, the assembly further comprising:
a second pump in fluid communication with said first pump; and
a centralized computer system coupled to said first pump and said second pump for simultaneous monitoring thereof.

24. The assembly of claim 23 further comprising a graphical user interface coupled to said centralized computer system for operator interaction
